(19) United States
(12) Patent Application Publication
(10) Pub. No.: US 2026/0225049 A1
(43) Pub. Date: Aug. 6, 2026

(54) IN-LINE CARBONATION SYSTEM

(71) Applicant: Pentair, Inc., Minneapolis, MN (US)

(72) Inventors: Jonathan William Slye, New Brighton, MN (US); Robert Orvin Crowder, Lino Lakes, MN (US); Mohan Khadilkar, Plymouth, MN (US); Joshua Thao, Coon Rapids, MN (US); John Krueger, Minneapolis, MN (US); Patrick Callaghan, St. Paul, MN (US)

(21) Appl. No.: 19/142,459

(22) PCT Filed: Dec. 22, 2023
(86) PCT No.: PCT/US2023/085830

§ 371 Date: Jun. 23, 2025

Related U.S. Application Data
(60) Provisional application No. 63/435,065, filed on Dec. 23, 2022.

(51) Int. Cl. B01F 23/236; B01F 23/231; B01F 23/237; B01F 25/433; B01F 35/21; B01F 35/71; B01F 35/75; B01F 35/90; B01F 101/14; B67D 1/00

(52) U.S. Cl. CPC B01F 23/2362; B01F 23/23121; B01F 23/237621; B01F 25/4331; B01F 35/2113; B01F 35/718051; B01F 35/75471; B01F 35/90; B67D 1/0058; B01F 2035/98; B01F 2101/14

(57) ABSTRACT

An inline carbonation system including a water source, a gas source, a mixing point, a pump, and a dispensing valve is provided. The water source is configured to supply a stream of water and the gas source is configured to supply a stream of gas. The mixing point is in fluid communication with the water source and the gas source. The stream of water mixes with the stream of gas at the mixing point to produce a fluid mixture and the pump is in fluid communication with the mixing point to pressurize the fluid mixture. The dispensing valve is in fluid communication with the pump to dispense the carbonated fluid mixture.

### CROSS-REFERENCES TO RELATED APPLICATIONS

This application claims priority under 35 U.S.C. § 119 to U.S. Provisional Patent Application No. 63/435,065, filed Dec. 23, 2022, the entire contents of which are incorporated herein by reference.

### BACKGROUND

For more than a century, tank-based carbonation has been the most widely utilized method of carbonation in the food service sector. More recently, devices have been developed to carbonate beverages at home. Often, these products use the traditional batch carbonation method.

Under the batch carbonation method, a pressurized storage tank holds carbonated water or soda at the ready to be dispensed. As the level of carbonated water in this tank decreases, a motor injects water into the carbon dioxide (CO2) pressurized headspace of the tank. The incoming water is atomized to maximize surface area contact with the CO2. As the water is sprayed into the tank, the CO2 dissolves into the water. Thus, the water is saturated with CO2 as the water collects in the bottom of the tank.

To prevent the tank from ever overfilling with carbonated water, the tank has a level switch. This level switch aids in maintaining a volume of pressurized gaseous CO2 above the carbonated water, preventing the dissolved CO2 in the carbonated water from degassing out and maintaining a saturated equilibrium of dissolved CO2 in the carbonated water.

Often, carbonated water is dispensed from the tank more quickly than atomized water is injected into the tank. Thus, if the tank-based dispensing systems are used to constantly dispense carbonated beverages for an extended period, the dispensing system will run out of carbonated water.

Additionally, traditional carbonated water dispensing systems often include high-pressure motor pump units and electronic switching, which are prone to malfunctions. Further, large, heavy carbonator tanks increase the expense of producing and repairing a beverage dispensing system.

Readily available carbonated water is desired for drinking, but standard, batch-style carbonators are often too large in size, too limited in capacity, and too expensive to buy and maintain. Therefore, there is a need for an improved carbonated water dispensing system that provides carbonated water quickly and efficiently for extended periods of time.

### SUMMARY

An inline carbonation system including a water source, a gas source, a mixing point, a first pump, and a dispensing valve is provided. The water source is configured to supply a stream of water and the gas source is configured to supply a stream of gas. The mixing point is in fluid communication with the water source and the gas source, whereby the stream of water mixes with the stream of gas at the mixing point to produce a fluid mixture. The first pump is in fluid communication with the mixing point to pressurize the fluid mixture and the dispensing valve is in fluid communication with the first pump to dispense the fluid mixture.

In some embodiments, the inline carbonation system also includes a recycle loop in fluid communication with an inlet and an outlet of the first pump to recirculate and reagitate the fluid mixture.

In some embodiments, the inline carbonation system further includes a second pump in fluid communication with the mixing point and the first pump.

In some embodiments, the inline carbonation system also includes a check valve in fluid communication with the water source and the mixing point, where the check valve is downstream of the water source and upstream of the mixing point.

In some embodiments, the inline carbonation system also includes a check valve in fluid communication with the gas source and the mixing point, wherein the check valve is downstream of the gas source and upstream of the mixing point.

In some embodiments, the mixing point is in fluid communication with the pump via a tubing coil.

In some embodiments, the pump pressurizes the fluid mixture to dissolve the gas into the water.

In some embodiments, the inline carbonation system also includes a control valve in fluid communication with the gas source and the mixing point, where the control valve is downstream of the gas source, upstream of the mixing point, and configured to control the stream of gas.

In some embodiments, the water source includes a chiller provided in the form of at least one of a glycol chiller, an ice bank chiller, a cold plate, or a piezo electric chiller. In some instances, the system may cycle carbonated water back to the chiller for further cooling downstream of the mixing point and upstream of the second pump inlet and/or downstream of the second pump outlet and upstream of the dispense point.

In some embodiments, a chilling loop is provided in fluid communication with the chiller and the first pump.

In some embodiments, the inline carbonation system also includes a pressure gauge and/or pressure switch configured to measure a pressure of the fluid mixture between the pump and the dispensing valve.

Some embodiments provide an inline carbonation system including a water source, an injector assembly, a mixing point, a pump, and a dispensing valve. The water source is configured to supply a stream of water and the injector assembly is configured to supply a stream of gas and includes a gas source. A control valve is in fluid communication with and downstream of the gas source, and an orifice is in fluid communication with and downstream of the control valve. The mixing point is in fluid communication with and downstream of the water source and the injector assembly. The stream of water mixes with the stream of gas at the mixing point to produce a fluid mixture. The pump is in fluid communication with and downstream of the mixing point to produce carbonated water from the fluid mixture. The dispensing valve is in fluid communication with and downstream of the pump to dispense the carbonated water.

In some embodiments, the inline carbonation system also includes a recycle loop in fluid communication with an inlet and an outlet of the pump to recirculate and reagitate the carbonated water.

In some embodiments, the inline carbonation system further includes a second pump in fluid communication with the mixing point and the first pump, where the second pump is downstream or upstream of the first pump.

In some embodiments, the inline carbonation system also includes a check valve in fluid communication with the water source and the mixing point, where the check valve is downstream of the water source and upstream of the mixing point.

In some embodiments, the inline carbonation system also includes a check valve in fluid communication with the gas source and the mixing point, wherein the check valve is downstream of the gas source and upstream of the mixing point.

In some embodiments, the mixing point is in fluid communication with the pump via a tubing coil.

In some embodiments, the inline carbonation system also includes a pressure gauge or pressure switch configured to measure a pressure of the carbonated water between the pump and the dispensing valve.

Some embodiments provide an inline carbonation system including a water source, a first pump, a gas source, a mixing point, a second pump, and a dispensing valve. The first pump is in fluid communication with the water source and is configured to draw a stream of water from the water source. The gas source is configured to supply a stream of gas. The mixing point is in fluid communication with and downstream of the first pump and the gas source. The stream of water mixes with the stream of gas at the mixing point to produce a fluid mixture. The second pump is in fluid communication with the mixing point to produce carbonated water from the fluid mixture. The dispensing valve is in fluid communication with the second pump to dispense the carbonated water.

In some embodiments, the inline carbonation system also includes a recycle loop in fluid communication with an inlet and an outlet of the second pump to recirculate and reagitate the carbonated water.

In some embodiments, the inline carbonation system also includes a control valve in fluid communication with the gas source and the mixing point, where the valve is downstream of the gas source, upstream of the mixing point, and configured to control the stream of gas.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a schematic diagram of a first carbonation system including a first injection assembly;

FIG. 2 is a flow diagram depicting a first method for operating at least one device within the first carbonation system of FIG. 1;

FIG. 3 is a schematic diagram of a second carbonation system including the first injection assembly of FIG. 1;

FIG. 4 is a schematic diagram of a third carbonation system including the first injection assembly of FIG. 1; and

FIG. 5 is a schematic diagram of a second injection assembly designed for use in the first, second, and third carbonation systems of FIGS. 1, 3, and 4, respectively.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein are for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

As used herein, unless otherwise specified or limited, “at least one of A, B, and C,” and similar other phrases, are meant to indicate A, or B, or C, or any combination of A, B, and/or C. As such, this phrase, and similar other phrases can include single or multiple instances of A, B, and/or C, and, in the case that any of A, B, and/or C indicates a category of elements, single or multiple instances of any of the elements of the categories A, B, and/or C.

The present system dispenses large volumes of carbonated water with real-time inline (e.g., continuous, substantially continuous, non-batch) carbonation. Continuous carbonation can be accomplished by injecting a controlled flow rate of carbon dioxide (CO2) into a known flow of chilled water. In the system, at least one water line is provided. The carbon dioxide line, or multiple lines, is also provided to mix the carbon dioxide into the water line.

The water flow rate is controlled by a first pump that is disposed upstream of the CO2 injection location. To prevent water from entering the CO2 line, a check valve is installed at the injection site allowing CO2 into the water line while at the same time preventing water from entering the CO2 line. To inject CO2 as a stream of smaller bubbles, a diffusing tube or sparger can be inserted at the injection site. By increasing the contact surface area between the water and CO2, the process by which CO2 dissolves in the water is sped up. Alternately, if the diffuser or sparger is constructed of a hydrophobic substance, the diffuser may prevent water from entering the CO2 line on its own, which may allow the check valve on the CO2 line at the injection location to be omitted. The CO2 begins to dissolve into solution as it is injected into the water line and flows through a length of tubing before going into a second pump.

The second pump, which also pressurizes the fluid for dispensing, mixes the solution once it has passed through the length of the tubing. In order to retain as much CO2 dissolved as possible, a recirculating mixing loop is associated with the second pump to allow any gas bubbles not dissolved to be re-agitated by the pump. Recirculating a portion of the flow also assists in distributing any pockets of undissolved CO2 that may develop during protracted periods of system inactivity. Additionally, a dispensing valve can be controlled to limit the output flow rate in order to maintain high pressure, which aids in dissolving CO2 and maintaining it in solution.

Additionally, using a chilled water line is beneficial to enhance the carbonation results because cooler water may dissolve more CO2 per unit of volume. In order to prevent water inside the pumps and tubing from warming up to ambient temperatures while the system is not in use, it may be useful to have one or more components of the system downstream of the chilled water source encased in a refrigerated environment or otherwise cooled. Alternatively, the carbonator may be provided upstream of the chiller. The carbonation results may be enhanced so long as the carbonated water is chilled before depressurization upon dispensing.

The present disclosure describes an inline carbonator that provides a continuous output of carbonated water. The inline carbonator includes a first pump to provide a flow of water to a mixing point where a flow of gaseous carbon dioxide (CO2) is introduced. The inline carbonator further includes a second pump to pressurize the gaseous CO2 and liquid water to dissolve the CO2 into the water, thus producing carbonated water ready for dispensing. High pressure to dissolve the CO2 into the water is maintained by restricting the flow of carbonated water before or at the dispense point. The second pump includes a recycle loop and a higher flow rate than the first pump. When a set pressure is reached between the second pump and the dispense point, the second pump recycles carbonated water. The recycle process further increases the dissolution of the CO2 into the water by repeatedly forcing the carbonated water through the second pump. The pumping action of the second pump increases mixing and decreases the bubble size of the CO2, thereby increasing dissolution. Thus, the present disclosure readily and continuously dispenses carbonated water with real-time carbonation.

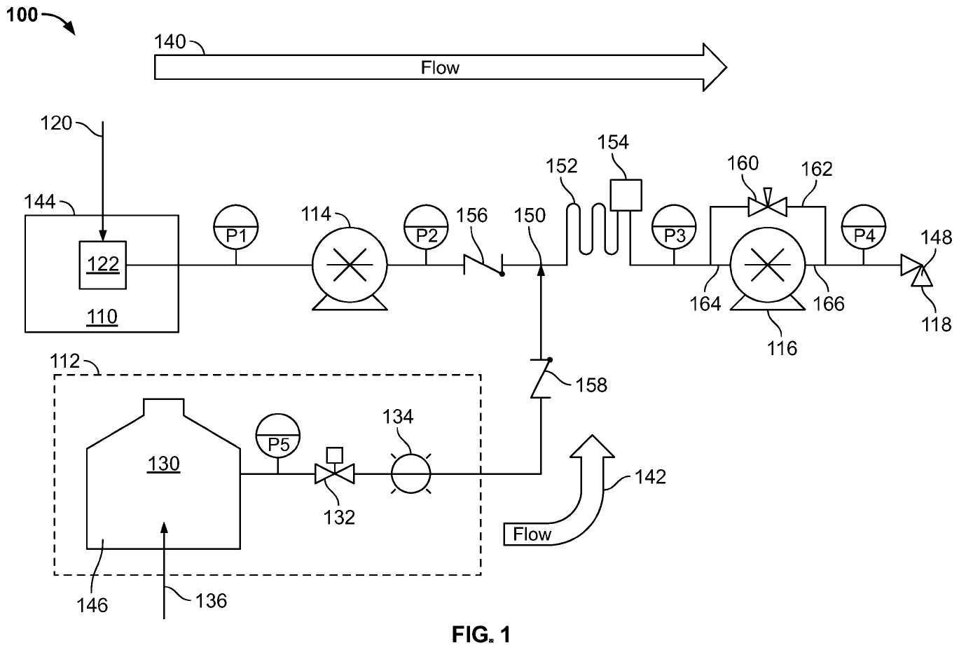

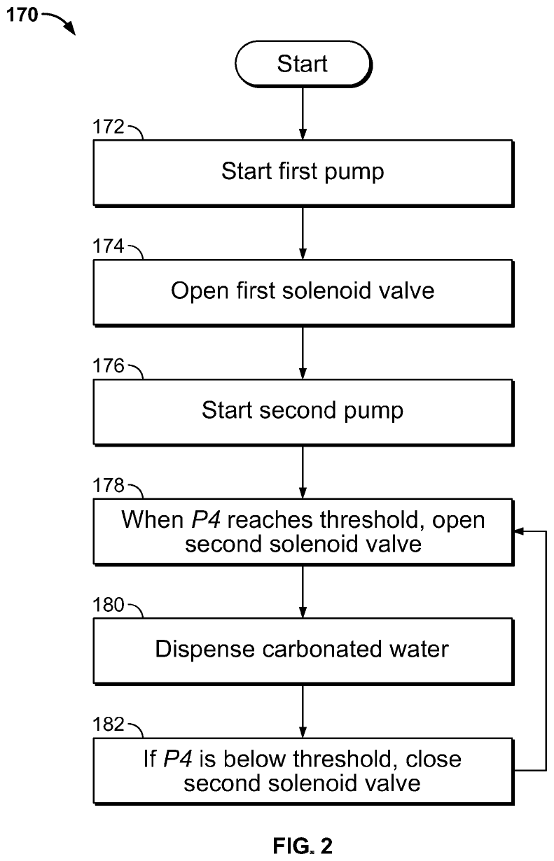

As explained above, it would be useful to provide an improved carbonated water dispensing system. More particularly, a carbonated water dispensing system that continuously provides carbonated water quickly and efficiently for extended periods. FIG. 1 illustrates a first carbonation system 100 according to the principles of this disclosure. The first carbonation system 100 includes a water source 110, a first injection assembly 112, an optional first pump 114 (shown in FIG. 2), a second pump 116, and a dispensing valve 118. The water source 110 is in fluid communication with and upstream of the first pump 114. The first pump 114 is in fluid communication with and may be upstream of the second pump 116. The second pump 116 is in fluid communication with and may be upstream of the dispensing valve 118. In some instances, the first pump 114 and the second pump 116 may be the individual heads of a dual-headed pump that operate at the same speed as one another.

The water source 110 includes an incoming water line 120 and a chiller or cold plate 122. The incoming water line 120 may be provided in the form of copper, stainless steel, rubber tubing, plastic, or similar materials. Water may be provided to or run through the chiller 122 to chill the water. The chiller 122 may be provided in the form of at least one of a glycol chiller, an ice bank chiller, or a piezo electric chiller. It is understood that the chiller 122 could be provided in the form of other cooling technologies. Thus, the water source 110 may, for example, provide chilled plain (e.g., non-carbonated) water at about atmospheric pressure (about 1 bar) or a pressure provided by a local municipal water supply. The water source 110 may be provided in the form of conventional tap water or a water container of any convenient form and size. The water source 110 may be tap water, packaged water, or any other source of flat, non-carbonated water.

The first injection assembly 112 includes a gas source 130, a first solenoid valve 132, and a first orifice 134. The gas source 130 provides a source of carbon dioxide gas. In some embodiments, the gas source 130 includes an incoming gas line 136 that may be made from copper, stainless steel, plastic, or similar types of materials. The gas source 130 may be any type of pressurized container or source, e.g., compressed gas line. The gas source 130 is designed to inject a predetermined flow rate of carbon dioxide gas based upon the water flow rate and desired level of carbonated water (e.g., carbonation level). The gas source 130 may be connected to multiple injection lines with flow controllers (or other regulating devices) or may be provided in varying sizes to provide variable carbonation levels.

Referring still to FIG. 1, uncarbonated water flows from the water source 110 to the dispensing valve 118, as indicated by a first flow arrow 140. Gaseous carbon dioxide (CO2) flows from the gas source 130 to the dispensing valve 118, as indicated by a second flow arrow 142. Thus, the water source 110 is a first upstream end 144, the gas source 130 is a second upstream end 146, and the dispensing valve 118 is a downstream end 148.

The first injection assembly 112 is in fluid communication with the first pump 114 and the second pump 116 via a mixing point 150. The mixing point 150 is in fluid communication with and upstream of the second pump 116 via a tubing coil 152. Thus, the mixing point 150 is downstream of the first pump 114. In operation, CO2 flow from the first injection assembly 112 is introduced to water flow from the first pump 114 at the mixing point 150 to produce a fluid mixture. To inject CO2 into the water flow, the mixing point 150 may, for example, be a three-way tee adapter, a diffusing tube, a sparger, etc. The mixing point 150 structure may be selected to inject the CO2 into the water as a stream of small bubbles, which may increase the rate of dissolution of CO2 into the water by increasing the contact surface area between the CO2 and the water. As CO2 is injected into the water, the CO2 begins to dissolve into solution while flowing toward the second pump 116. The tubing coil 152 aids in dissolving the CO2 by increasing the volume and time in which the CO2 and water mix. In some embodiments, the first carbonation system 100 further includes a static mixer 154 along the tubing coil 152 to further aid in dissolving CO2 into the water.

In the first injection assembly 112, the gas source 130 is in fluid communication with and upstream of the first solenoid valve 132. Further, the first solenoid valve 132 is in fluid communication with and upstream of the first orifice 134. The first solenoid valve 132 selectively controls and/or releases the flow of CO2 from the gas source 130 to the first orifice 134. Additionally, in some embodiments, the first orifice 134 is adjustable. In operation, the first solenoid valve 132 and/or the first orifice 134 regulate the pressure of the carbon dioxide gas flow from the gas source 130. Thus, by modulating the first solenoid valve 132 to control the pressure P5 and/or the first orifice 134, the first injection assembly 112 may provide variable and/or intermediate carbonation levels on demand.

The first carbonation system 100 further includes a first check valve 156 and a second check valve 158. As illustrated in FIG. 1, the first check valve 156 is in fluid communication with and provided between the first pump 114 and the mixing point 150. Thus, the first check valve 156 is downstream of the first pump 114 and upstream of the mixing point 150. The first check valve 156 allows water to flow from the first pump 114 to the mixing point 150, while at the same time prohibits water and CO2 flow from the mixing point 150 back toward the first pump 114. As also shown in FIG. 1, the second check valve 158 is in fluid communication with and between the first orifice 134 and the mixing point 150. Thus, the second check valve 158 is downstream of the first orifice 134 and upstream of the mixing point 150. The second check valve 158 allows CO2 to flow from the first orifice 134 to the mixing point 150 and prohibits water and CO2 flow from traveling from the mixing point 150 back toward the first orifice 134.

The second pump 116 includes an inlet 164 and an outlet 166, which are in fluid communication with one another via a recycle loop 162. A second valve 160 (e.g., a needle valve or a pressure driven bypass valve) is disposed along a recycle loop 162 and selectively controls the flow of carbonated water from the outlet 166 to the inlet 164 via the recycle loop 162. In operation, the first pump 114 and the second pump 116 determine and control the water flow rate and the fluid mixture flow rate. In some instances, the second pump 116 operates at a greater flow rate than the first pump 114 to induce mixing. Thus, in such instances, when the second valve 160 is open, fluid is urged through the recycle loop 162 from the outlet 166 and recycled toward the inlet 164. In operation, the second pump 116 pressurizes the CO2 and water mixture between the outlet 166 and the dispensing valve 118 where the CO2 is forced into solution with the water before dispensing. The dispensing valve 118 aids in maintaining this pressurization by restricting carbonated water flow. Using the recycle loop 162 and the second pump 116 to recirculate and reagitate carbonated water increases mixing and decreases the CO2 bubble size. Thus, the recycle loop 162 and the second pump 116 aid in keeping CO2 dissolved in the water waiting to be dispensed via the dispensing valve 118.

Additionally, the first pump 114 and/or the second pump 116 may further include an internal bypass valve (not shown) that is designed to limit the maximum internal pressure and/or an external bypass valve (not shown) designed to limit the maximum outlet pressure. The bypass pressures are adjustable to control pressure throughout the first carbonation system 100 and protect the motors and internal components of the first pump 114 and the second pump 116. The bypasses can replace or augment the recycle loop 162.

In some instances, setting the cam angle of the second pump 116 (cam B) to be larger than the cam angle of the first pump 114 (cam A) causes the flow through the second pump 116 to exceed the flow through the first pump 114, even if the pumps are operating at the same rotational speed, thereby increasing the amount of water traveling through the mixing loop 162. Therefore, such additional mixing time can improve achievable carbonation levels. Additionally, recirculating a portion of the flow also helps disperse any undissolved pockets of carbon dioxide that may form during lengthy idle periods of the system 100. More importantly, increasing or decreasing the cam angle of both pumps (114, 116) equally allows for the overall flow rate of the system 100 to be adjustable for different applications.

Still referring to FIG. 1, the first carbonation system 100 may also include a first pressure gauge PI, a second pressure gauge P2, a third pressure gauge P3, a fourth pressure gauge P4, and/or a fifth pressure gauge P5. In some instances, the system 100 may have more or fewer pressure gauges. Also, in some instances, the pressure gauges may be provided in the form of pressure switches or other devices designed to measure pressure.

The first pressure gauge PI may be in fluid communication with and may measure a first pressure between the water source 110 and the first pump 114. The second pressure gauge P2 may be in fluid communication with and may measure a second pressure between the first pump 114 and the first check valve 156.

The third pressure gauge P3 may be in fluid communication with the first check valve 156, the second check valve 158, and/or the inlet 164 of the second pump 116. The third pressure gauge P3 may be between the mixing point 150 and the inlet 164. Thus, the third pressure gauge P3 may measure a third pressure upstream of the inlet 164 and downstream of the first check valve 156, the second check valve 158, and/or the mixing point 150. In some embodiments, the third pressure gauge P3 may measure the third pressure within the tubing coil 152.

In operation, a substantially stable system is formed when the pressure P3 in the water line is increased if all of the carbon dioxide does not go into solution. This causes the pressure drop across the orifice 134 to decrease and thereby decrease the flow rate of carbon dioxide. The impact on the carbon dioxide flow rate caused by such pressure changes in the water line will be minimized the greater the initial pressure drop between P3 and P5. In some instances, the solenoid valve 132 may be omitted.

The fourth pressure gauge or pressure switch P4 is in fluid communication with and measures a fourth pressure between the outlet 166 of the second pump 116 and the dispensing valve 118. In some embodiments, in operation, when the fourth pressure reaches a threshold (e.g., about 5 bar to about 10 bar, or about 6 to about 9 bar, or about 6.9 bar to about 8.3 bar), the second valve 160 opens for the second pump 116 to recycle the carbonated water between the outlet 166 and the dispensing valve 118. The fifth pressure gauge P5 may be in fluid communication with and measure a fifth pressure between the gas source 130 and the first solenoid valve 132.

In use, the amount of carbon dioxide gas dissolved within the water can be adjusted by adjusting the gas pressure, and thus the CO2 flow rate through the orifice during periods of dispensing. Alternately, providing one or more different orifices or one or more orifices having variable orifice sizes (with respect to each other) can be used to provide different CO2 flow rates. The use of gas pressure or orifice size may provide a target carbonation level desired by the user.

Moreover, in one instance, the system 100 and/or any number of its components may be positioned within, adjacent to, or in communication with at least one of a refrigerator or other suitable chilling enclosure to keep the system 100, its components, and/or the carbonated water chilled during and/or after the operation of the system 100.

Referring to FIG. 2, a flow diagram showing a method 170 for operating the first carbonation system 100 of FIG. 1 is shown. The method 170 starts at block 172, where the first pump 114 is started to begin water flow from the water source 110. The method 170 proceeds to block 174.

At block 174, the first solenoid valve 132 is opened to begin CO2 flow from the gas source 130. The method proceeds to block 176.

At block 176, the second pump 116 is turned on, which results in water and CO2 being sent toward the dispensing valve 118. As the second pump 116 runs, water and CO2 meet at the mixing point 150, where CO2 begins dissolving into the water. CO2 continues to dissolve into the water as the fluid mixture travels through the tubing coil 152 toward the second pump 116. The fluid mixture passes through and is pressurized by the second pump 116 between the second pump 116 and the dispensing valve 118, which dissolves additional CO2 into the water to produce carbonated water. The method 170 proceeds to block 178.

At block 178, the second valve 160 is opened when the fourth pressure measured by the fourth pressure gauge P4 reaches the threshold to recirculate carbonated water from the outlet 166 to the inlet 164 of the second pump 116, which maintains the pressurization of the carbonated water and further dissolves CO2 into the water. The method 170 proceeds to block 180.

At block 180, the carbonated water is dispensed via the dispensing valve 118, which controls the carbonated water dispense flow rate. The method 170 proceeds to block 182.

At block 182, if the fourth pressure measured by the fourth pressure gauge P4 is below the threshold, the second valve 160 is closed while the second pump 116 continues to run. Thus, the carbonated water between the second pump 116 and the dispensing valve 118 is repressurized. The method 170 then returns to block 178.

Although the method 170 for operating the first carbonation system 100 is described hereinabove with blocks 172, 174, 176, 178, 180, and 182, in some instances, it possible for one or more of the blocks 172, 174, 176, 178, 180, and/or 182 to operate substantially simultaneously.

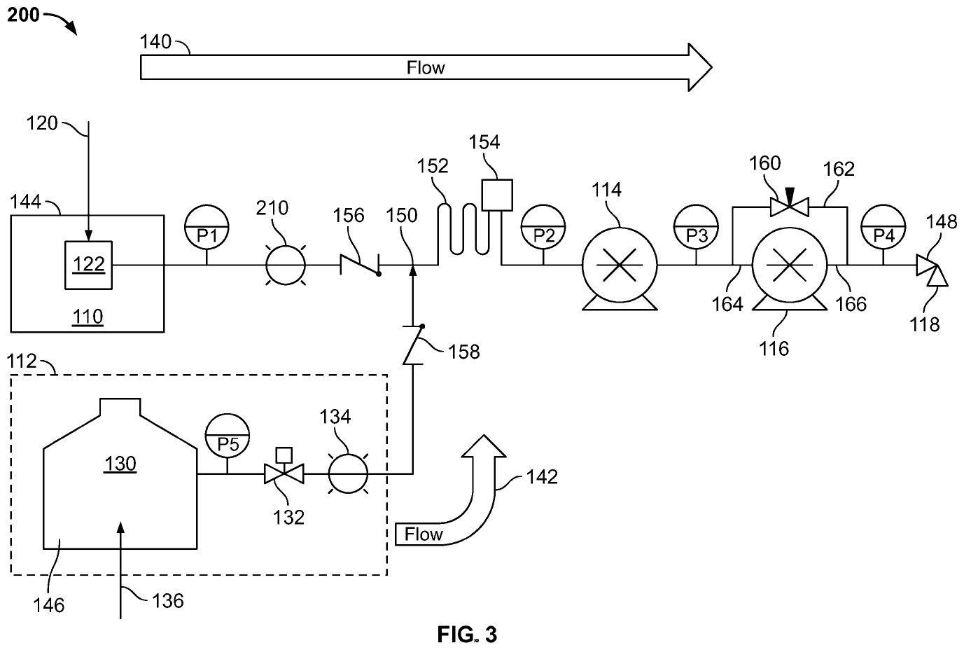

FIG. 3 depicts a second carbonation system 200 according to the principles of this disclosure. The second carbonation system 200 includes the above-described elements of the first carbonation system 100 of FIG. 1 and further includes a second orifice 210. It should be understood that, while the second carbonation system 200 includes the elements of the first carbonation system 100, the arrangement of the elements in the second carbonation system 200 differs from the arrangement of the elements in the first carbonation system 100. Thus, while the above-described elements each individually operate in the same manner in the second carbonation system 200 as in the first carbonation system 100, certain aspects of the operation of the second carbonation system 200 differ from that of the first carbonation system 100. In this system, the orifice 210 is used instead of the first pump 114 to maintain a consistent influent flow of water. In this configuration, if a dual-headed pump is being used, this orientation requires cam A to be equal to or smaller than cam B. Otherwise, the flow in the mixing loop 162 will end up by-passing the second pump 116 instead of recirculating around it.

As illustrated in FIG. 3, water flows from the water source 110 to the dispensing valve 118, as indicated by the first flow arrow 140. CO2 flows from the gas source 130 to the dispensing valve 118, as indicated by the second flow arrow 142. Thus, the water source 110 is the first upstream end 144, the gas source 130 is the second upstream end 146, and the dispensing valve 118 is the downstream end 148.

The water source 110 is in fluid communication with and upstream of the second orifice 210 and the second orifice 210 is in fluid communication with and upstream of the first pump 114. The first pump 114 is in fluid communication with and upstream of the second pump 116. The second pump 116 is in fluid communication with and upstream of the dispensing valve 118.

As depicted in FIG. 3, the first injection assembly 112 is in fluid communication with the first pump 114 and the second orifice 210 via the mixing point 150. The mixing point 150 is in fluid communication with and upstream of the first pump 114 via the tubing coil 152. Thus, the mixing point 150 is downstream of the second orifice 210. Additionally, the first pump 114 is downstream of tubing coil 152. In operation, CO2 flow from the first injection assembly 112 is introduced to water flow from the second orifice 210 at the mixing point 150. In some embodiments, the second carbonation system 200 includes the static mixer 154 along the tubing coil 152 to aid in dissolving CO2 into the water.

Remaining with FIG. 3, in the first injection assembly 112, the gas source 130 is in fluid communication with and upstream of the first solenoid valve 132. Further, the first solenoid valve 132 is in fluid communication with and upstream of the first orifice 134.

As illustrated in FIG. 3, the first check valve 156 is in fluid communication with and between the second orifice 210 and the mixing point 150. Thus, the first check valve 156 is downstream of the second orifice 210 and upstream of the mixing point 150. The first check valve 156 allows water to flow from the second orifice 210 to the mixing point 150, yet blocks water and CO2 flow from the mixing point 150 back toward the second orifice 210. The second check valve 158 is in fluid communication with and between the first orifice 134 and the mixing point 150. Thus, the second check valve 158 is downstream of the first orifice 134 and upstream of the mixing point 150. The second check valve 158 allows CO2 to flow from the first orifice 134 to the mixing point 150, yet blocks water and CO2 flow from the mixing point 150 back toward the first orifice 134.

The second carbonation system 200 further includes the second valve 160 disposed along the recycle loop 162. The inlet 164 and the outlet 166 of the second pump 116 are in fluid communication with one another via the recycle loop 162. The second valve 160 selectively controls the flow of carbonated water from the outlet 166 to the inlet 164 via the recycle loop 162. In some instances, the second pump 116 operates at a greater flow rate than the first pump 114. Thus, in such instances, when the second valve 160 is open, fluid is urged through the recycle loop 162 from the outlet 166 toward the inlet 164. In operation, the second pump 116 pressurizes the CO2 and water mixture between the outlet 166 and the dispensing valve 118 where the CO2 is forced into solution with the water before dispensing. The dispensing valve 118 maintains pressurization and restricts the flow of carbonated water while the recycle loop 162 and the second pump 116 recirculate and reagitate the carbonated water. Thus, the dispensing valve 118, the recycle loop 162, and the second pump 116 aid in keeping CO2 dissolved in the carbonated water waiting to be dispensed.

Additionally, the first pump 114 and/or the second pump 116 may further include an internal bypass valve (not shown) designed to limit the maximum internal pressure and/or an external bypass valve (not shown) designed to limit the maximum outlet pressure. The bypass pressures are adjustable to control pressure throughout the second carbonation system 200 and protect the motors and internal components of the first pump 114 and the second pump 116. In the system 100, the external bypass valve P4 set at about 100 to about 120 psi may be associated with the second pump 116 in order to keep the dispensing pressure high enough to provide adequate carbonation while preventing the pressure from getting too high and damaging the system 100. The bypasses can replace or augment the recycle loop 162.

The second carbonation system 200 may further include various optional pressure gauges. In particular, the first pressure gauge PI may be in fluid communication with and may measure a first pressure between the water source 110 and the second orifice 210. The second pressure gauge P2 may be in fluid communication with the first check valve 156, the second check valve 158, and/or the first pump 114. The second pressure gauge P2 may be disposed between the mixing point 150 and the first pump 114. Thus, the second pressure gauge P2 may measure a second pressure upstream of the first pump 114 and downstream of the first check valve 156, the second check valve 158, and/or the mixing point 150. In some embodiments, the second pressure gauge P2 may measure the second pressure within the tubing coil 152.

The third pressure gauge P3 may be in fluid communication with and may measure a third pressure between the first pump 114 and the inlet 164 of the second pump 116. The fourth pressure gauge P4 may be in fluid communication with and may measure a fourth pressure between the outlet 166 of the second pump 116 and the dispensing valve 118. In some embodiments, in operation, when the fourth pressure reaches a threshold (e.g., about 5 bar to about 10 bar, or about 6 to about 9 bar, or about 6.9 bar to about 8.3 bar), the second valve 160 opens for the second pump 116 to recycle the carbonated water between the outlet 166 and the dispensing valve 118. The fifth pressure gauge P5 may be in fluid communication with and may measure a fifth pressure between the gas source 130 and the first solenoid valve 132. Although the system 200 is described as having five pressure gauges, the system 200 may have more or fewer pressure gauges. Also, in some instances, the pressure gauges may be pressure switches or other devices designed to measure pressure.

Continuing with FIG. 3, in one instance, the carbonation system 200 may include one or more chillers in fluid communication with one or more components of the system 200 to facilitate cooling the uncarbonated or carbonated water. For example, the system 200 may include the chiller 122 and a second chiller (not shown) positioned downstream of the pump 116.

Moreover, the carbonation system 200 may further include at least one chilling loop (not shown) to facilitate providing additional chilling or cooling of the carbonated water within the system 200, preferably downstream of the mixing point 150. For example, a chilling loop may be provided between the chiller 122 and the first pump 114. Another chilling loop may be provided between the chiller 122 and a point between the first pump 114 and the mixing point 150. A further chilling loop may be provided between the chiller 122 and a point between the mixing point 150 and the second pump 116. An additional chilling loop may be provided between the chiller 122 and a point between the second pump 116 and the dispense valve 118.

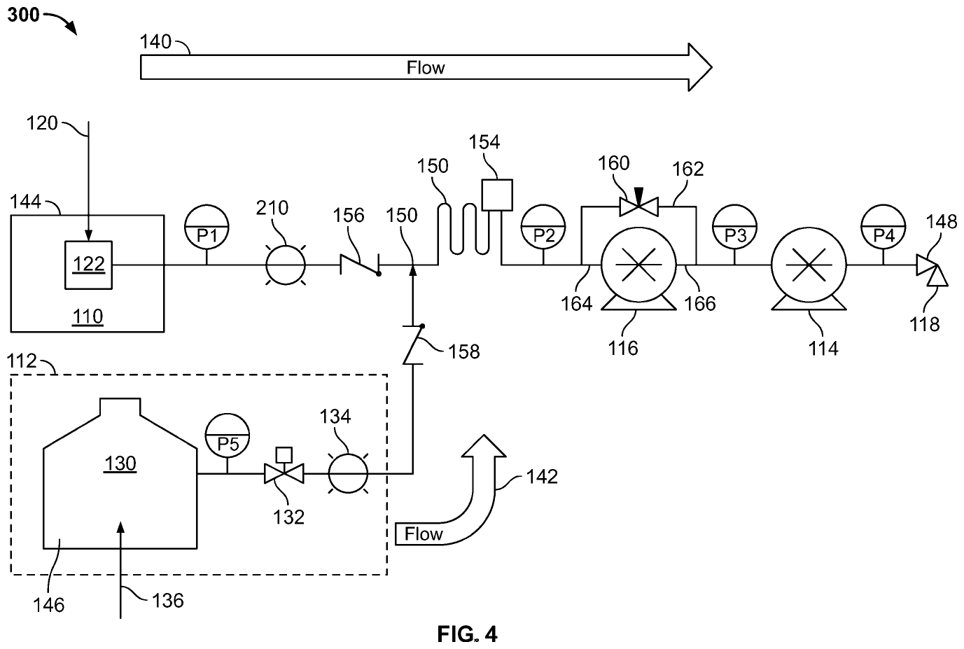

FIG. 4 depicts a third carbonation system 300 including the above-described elements of the second carbonation system 200 of FIG. 2. It should be understood that, while the third carbonation system 300 includes the elements of the second carbonation system 200, the arrangement of these elements in the third carbonation system 300 differs from the arrangement of the elements in the second carbonation system 200. For example, the system 300 includes the pump 116 upstream of the pump 114. Thus, while the above-described elements each individually operate in the same manner in the third carbonation system 300 as in the second carbonation system 200, certain aspects of the operation of the third carbonation system 300 differ from that of the second carbonation system 200. The system 300 maximizes the mixing potential of the dual-headed pump but utilizes the recycle loop 162 in conjunction with the pump 116. Due to a change in the location of the recycle loop 162, cam A should be equal to or larger than cam B if a dual-headed pump is used to ensure the recycle loop 162 doesn't allow flow to bypass the pump 116.

As illustrated in FIG. 4, water flows from the water source 110 to the dispensing valve 118, as indicated by the first flow arrow 140. CO2 flows from the gas source 130 to the dispensing valve 118, as indicated by the second flow arrow 142. Thus, the water source 110 is the first upstream end 144, the gas source 130 is the second upstream end 146, and the dispensing valve 118 is the downstream end 148.

The water source 110 is in fluid communication with and upstream of the second orifice 210. The second orifice 210 is in fluid communication with and upstream of the pump 116. As shown in FIG. 4, in one instance, the pump 116 is in fluid communication with and upstream of the pump 114. The pump 116 and/or the pump 114 is in fluid communication with and upstream of the dispensing valve 118.

The first injection assembly 112 is in fluid communication with the pump 116 and the second orifice 210 via the mixing point 150. The mixing point 150 is in fluid communication with and upstream of the inlet 164 via the tubing coil 152. Thus, the mixing point 150 is downstream of the second orifice 210. Additionally, the pump 116 is downstream of the tubing coil 152. In operation, CO2 flow from the first injection assembly 112 is introduced to water flow from the second orifice 21f0 at the mixing point 150. In some embodiments, the third carbonation system 300 includes the static mixer 154 along the tubing coil 152 to aid in dissolving CO2 into the water.

With respect to the first injection assembly 112, the gas source 130 is in fluid communication with and upstream of the first solenoid valve 132. Further, the first solenoid valve 132 is in fluid communication with and upstream of the first orifice 134.

The first check valve 156 is in fluid communication with and between the second orifice 210 and the mixing point 150. Thus, the first check valve 156 is downstream of the second orifice 210 and upstream of the mixing point 150. The first check valve 156 allows water to flow from the second orifice 210 to the mixing point 150 and prohibits water and CO2 from flowing from the mixing point 150 back toward the second orifice 210. The second check valve 158 is in fluid communication with and disposed between the first orifice 134 and the mixing point 150. Thus, the second check valve 158 is downstream of the first orifice 134 and upstream of the mixing point 150. The second check valve 158 allows CO2 to flow from the first orifice 134 to the mixing point 150 and prohibits water and CO2 from flowing from the mixing point 150 back toward the first orifice 134.

Still referring to FIG. 4, the third carbonation system 300 also includes the second valve 160 disposed along the recycle loop 162. The inlet 164 and the outlet 166 of the pump 116 are in fluid communication with one another via the recycle loop 162. The second valve 160 selectively controls the flow of carbonated water from the outlet 166 to the inlet 164 via the recycle loop 162. In some instances, the pump 116 operates at a greater flow rate than the pump 114. Thus, in such instances, when the second valve 160 is open, fluid is urged through the recycle loop 162 from the outlet 166 toward the inlet 164. In operation, the pump 116 pressurizes the CO2 and water mixture between the outlet 166 and the pump 114 to dissolve the CO2 into the water. Additionally, the recycle loop 162 and the pump 116 recirculate and reagitate the carbonated water to aid in dissolving CO2 into the water. The pump 114 further pressurizes the CO2 and water mixture against the dispensing valve 118 to further force the CO2 into solution with the water before dispensing. The dispensing valve 118 maintains pressurization and restricts the flow of carbonated water. Thus, the dispensing valve 118, the recycle loop 162, and the pump 116 aid in keeping CO2 dissolved in the carbonated water waiting to be dispensed.

In other instances, the pump 114 may operate at a greater flow rate than the pump 116. In this instance, the recycle loop 162 acts as a bypass relative to the pump 116 by opening the second valve 160. When the second valve 160 is open, fluid is drawn around the pump 116 from the inlet 164 to the outlet 166 through the recycle loop 162 by the pump 114. Using the recycle loop 162 as a bypass may, for example, help clean the second carbonation system 200, purging the second carbonation system 200 of fluid, performing maintenance on the second carbonation system 200, etc.

As described above, the pump 114 and/or the pump 116 may further include an internal bypass valve (not shown) designed to limit the maximum internal pressure and/or an external bypass valve (not shown) designed to limit the maximum outlet pressure. The bypass pressures are adjustable to control pressure throughout the third carbonation system 300 and protect the motors and internal components of the pump 114 and the pump 116. These bypasses can replace or augment the recycle loop 162.

In the third carbonation system 300, the first pressure gauge PI may be in fluid communication with and may measure a first pressure between the water source 110 and the second orifice 210. The second pressure gauge P2 may be in fluid communication with the first check valve 156, the second check valve 158, and/or the pump 116. The second pressure gauge P2 may be disposed between the mixing point 150 and the pump 116. Thus, the second pressure gauge P2 may measure a second pressure upstream of the s pump 116 and downstream of the first check valve 156, the second check valve 158, and/or the mixing point 150. In some embodiments, the second pressure gauge P2 may measure the second pressure within the tubing coil 152.

The third pressure gauge P3 may be in fluid communication with and may measure a third pressure between the pump 114 and the outlet 166 of the pump 116. In some embodiments, in operation, when the third pressure reaches a threshold (e.g., about 5 bar to about 10 bar, or about 6 to about 9 bar, or about 6.9 bar to about 8.3 bar), the second valve 160 opens for the pump 116 to recycle the carbonated water between the outlet 166 and the dispensing valve 118. The fourth pressure gauge P4 may be in fluid communication with and may measure a fourth pressure between the pump 114 and the dispensing valve 118. The fifth pressure gauge P5 may be in fluid communication with and may measure a fifth pressure between the gas source 130 and the first solenoid valve 132. Although the system 300 is described as having five pressure gauges, the system 300 may have more or fewer pressure gauges. Also, in some instances, the pressure gauges may be pressure switches or other devices designed to measure pressure.

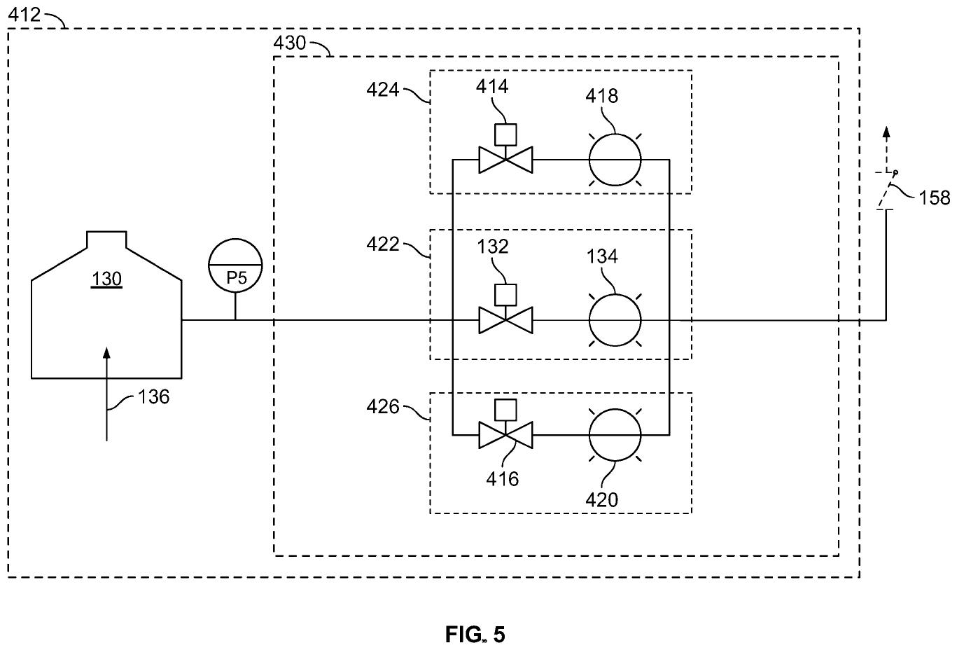

FIG. 5 illustrates a second injection assembly 412 usable as an alternative to the first injection assembly 112 in the first, second, and third carbonation systems 100, 200, 300 of FIGS. 1, 3, and 4, respectively, according to the principles of this disclosure. The second injection assembly 412 is configured to fluidly couple to the second check valve 158. Thus, in some instances, the first injection assembly 112 may be fluidly uncoupled from the second check valve 158 and directly replaced with the second injection assembly 412.

As shown in FIG. 5, the second injection assembly 412 includes the gas source 130, the first solenoid valve 132, the first orifice 134, the incoming gas line 136, and the fifth pressure gauge P5. The second injection assembly 412 further includes a third (e.g., solenoid) valve 414, a fourth (e.g., solenoid) valve 416, a third orifice 418, and a fourth orifice 420.

The first solenoid valve 132 is in fluid communication with and upstream of the first orifice 134 to form a first equipment pair 422. The third valve 414 is in fluid communication with and upstream of the third orifice 418 to form a second equipment pair 424. The fourth valve 416 is in fluid communication with and upstream of the fourth orifice 420 to form a third equipment pair 426. The first equipment pair 422, the second equipment pair 424, and the third equipment pair 426 are arranged in parallel flow with respect to one another and may be collectively referred to as a manifold 430.

The first solenoid valve 132, the third valve 414, and the fourth valve 416 are in fluid communication with and downstream of the gas source 130. The first orifice 134, the third orifice 418, and the fourth orifice 420 are configured to fluidly couple with and be upstream of the second check valve 158.

The fifth pressure gauge P5 measures the fifth pressure between the gas source 130 and the manifold 430. Additionally, the first orifice 134, the third orifice 418, and the fourth orifice 420 are imparted with diameters that vary. In operation, by modulating and/or adjusting the first solenoid valve 132, the third valve 414, and the fourth valve 416, the manifold 430 may deliver differing flow rates of CO2. The first equipment pair 422, the second equipment pair 424, and the third equipment pair 426 may, alone or in combination, be used to provide a desired carbonation level. Thus, desired carbonation levels are achieved and delivered to the user depending on which of the first solenoid valve 132, the third valve 414, and the fourth valve 416 are positioned in an open configuration.

In other embodiments, other configurations are possible. For example, those of skill in the art will recognize, according to the principles and concepts disclosed herein, that various combinations, sub-combinations, and substitutions of the components discussed above can provide appropriate cooling for a variety of different configurations of motors, pumps, electronic assemblies, and so on, under a variety of operating conditions.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

1. An inline carbonation system, comprising:
a water source configured to supply a stream of uncarbonated water;
a gas source configured to supply a stream of gas;
a mixing point in fluid communication with the water source and the gas source, the stream of water mixing with the stream of gas at the mixing point to produce a carbonated fluid mixture;
a first pump in fluid communication with the mixing point to pressurize the fluid mixture; and
a dispensing valve in fluid communication with the first pump to dispense the carbonated fluid mixture.

2. The inline carbonation system of claim 1, further comprising a recycle loop in fluid communication with an inlet and an outlet of the first pump to recirculate and reagitate the fluid mixture.

3. The inline carbonation system of claim 1 further comprising a second pump in fluid communication with the mixing point and the first pump.

4. The inline carbonation system of claim 1, further comprising a check valve in fluid communication with the water source and the mixing point, the check valve being downstream of the water source and upstream of the mixing point.

5. The inline carbonation system of claim 1, further comprising a check valve in fluid communication with the gas source and the mixing point, the check valve being downstream of the gas source and upstream of the mixing point.

6. The inline carbonation system of claim 1, wherein the mixing point is in fluid communication with the first pump via a tubing coil.

7. The inline carbonation system of claim 1, wherein the first pump pressurizes the fluid mixture to dissolve the gas into the water.

8. The inline carbonation system of claim 1, further comprising a control valve in fluid communication with the gas source and the mixing point, the control valve being downstream of the gas source, upstream of the mixing point, and configured to control the stream of gas.

9. The inline carbonation system of claim 1, wherein the water source includes a chiller provided in the form of at least one of a glycol chiller, an ice bank chiller, a cold plate, or a piezo electric chiller.

10. The inline carbonation system of claim 9, further comprising a chilling loop in fluid communication with the chiller and the first pump.

11. The inline carbonation system of claim 1, further comprising a pressure gauge or pressure switch configured to measure a pressure of the fluid mixture between the first pump and the dispensing valve.

12. An inline carbonation system comprising:
a water source configured to supply a stream of uncarbonated water;
an injector assembly configured to supply a stream of gas, the injector assembly including
a gas source,
a control valve in fluid communication with and downstream of the gas source, and
an orifice in fluid communication with and downstream of the control valve;
a mixing point in fluid communication with and downstream of the water source and the injector assembly, the stream of water mixing with the stream of gas at the mixing point to produce a fluid mixture;
a first pump in fluid communication with and downstream of the mixing point to produce carbonated water from the fluid mixture; and
a dispensing valve in fluid communication with and downstream of the first pump to dispense the carbonated water.

13. The inline carbonation system of claim 12, further comprising a recycle loop in fluid communication with an inlet and an outlet of the first pump to recirculate and reagitate the carbonated water.

14. The inline carbonation system of claim 13, further comprising a second pump in fluid communication with the mixing point and the first pump, the second pump facilitating a higher flow rate of fluid therethrough to send a portion of the stream of water to the recycle loop.

15. The inline carbonation system of claim 14, wherein the stream of water is chilled after passing through the second pump and prior to passing through the dispensing valve.

16. The inline carbonation system of claim 12, wherein the control valve is provided in the form of a solenoid valve designed to control a flow rate of carbon dioxide to the mixing point.

17. The inline carbonation system of claim 16, wherein the solenoid valve is in communication with a check valve.

18. The inline carbonation system of claim 12, wherein at least one of a sparger or diffusing tube is in communication with the injector assembly to provide carbon dioxide in a stream of small bubbles.

19. An inline carbonation system comprising:
a water source;
a first pump in fluid communication with the water source and configured to draw a stream of water from the water source;
a gas source configured to supply a stream of gas;
a mixing point in fluid communication with and downstream of the first pump and the gas source, the stream of water mixing with the stream of gas at the mixing point to produce a fluid mixture;
a second pump in fluid communication with the mixing point to produce carbonated water from the fluid mixture; and
a dispensing valve in fluid communication with the second pump to dispense the carbonated water.

20. The inline carbonation system of claim 19, further comprising a recycle loop in fluid communication with an inlet and an outlet of the second pump to recirculate and reagitate the carbonated water.
